(19) United States
(12) Patent Application Publication
(10) Pub. No.: US 2021/0194096 A1
(43) Pub. Date: Jun. 24, 2021

(54) IONIC COMPOUND-BASED ELECTROCATALYST FOR THE ELECTROCHEMICAL OXIDATION OF HYPOPHOSPHITE

(71) Applicant: The Board of Trustees of the Leland Stanford Junior Univeristy, Stanford, CA (US)

(72) Inventors: Adam Christopher Nielander, Stanford, CA (US); Thomas Francisco Jaramillo, Stanford, CA (US); Laurie A. King, Stanford, CA (US); Joel Sanchez, Stanford, CA (US)

(73) Assignee: The Board of Trustees of the Leland Stanford Junior University, Stanford, CA (US)

(21) Appl. No.: 17/127,203

(22) Filed: Dec. 18, 2020

Related U.S. Application Data
(60) Provisional application No. 62/951,203, filed on Dec. 20, 2019.

(51) Int. Cl. H01M 50/497; B01J 27/185; H01M 4/90

(52) U.S. Cl. CPC H01M 50/497; H01M 8/1004; H01M 4/9041; B01J 27/1853

(57) ABSTRACT

Embodiments of this disclosure include fuel cells, e.g., comprising an anode; a cathode; and an ion conducting membrane disposed between the anode and the cathode, wherein the anode includes an anode catalyst layer including an ionic compound of a base metal, which is a non-precious metal, and a non-metal, which is not oxygen. Further embodiments include methods of hypophosphite oxidation, e.g., comprising providing an electrode including a catalyst layer, wherein the catalyst layer includes an ionic compound of a base metal, which is a non-precious metal, and a non-metal, which is not oxygen; and exposing hypophosphite to the electrode while applying a potential to the electrode

### CROSS-REFERENCE TO RELATED APPLICATIONS

This application claims the benefit of and priority to U.S. Patent Application No. 62/951,203, filed on Dec. 20, 2019, the contents of which are incorporated herein in their entirety.

### BACKGROUND

Hypophosphite fuel cells rely on the efficient oxidation of hypophosphite (H₂PO₂⁻) to enhance performance. There are a few number of materials identified thus far as capable of catalyzing hypophosphite oxidation. A particularly active electrocatalyst, palladium, is a precious metal, which imposes a high cost and impedes widespread deployment. Therefore, identifying hypophosphite electrocatalysts based on earth abundant materials would promote the further development of hypophosphite-driven fuel cells.

It is against this background that a need arose to develop the embodiments described herein.

### BRIEF DESCRIPTION OF THE DRAWINGS

FIG. 1 shows an embodiment of a schematic of a direct hypophosphite fuel cell according to some embodiments. The fuel cell includes an anode, a cathode, and ion conducting membrane (in the form of an anion exchange membrane (AEM)) disposed between the anode and the cathode.

FIG. 2 shows an embodiment of hypophosphite oxidation activity with a nickel phosphide electrode undergoing cyclic voltammetry. As shown, a positive current between −0.3 V and +0.1 V is indicative of desired catalytic activity.

FIG. 3 shows an embodiment of a comparative pure nickel electrode did not demonstrate the same level of oxidation activity.

FIG. 4 shows an embodiment of extended characterization of a nickel phosphide electrode, and over 10 minutes of stability is demonstrated, as reflected in the relatively stable current density over this time period.

### DETAILED DESCRIPTION

Embodiments of this disclosure are directed to an improved material, an ionic compound, for electrochemically catalyzing hypophosphite oxidation. Unlike comparative hypophosphite electrocatalysts, the ionic compound does not include any precious metal and therefore is competitive on a cost-basis and can provide high performance. In some embodiments, the ionic compound is a base metal-containing, binary compound of the base metal and a non-metal. In some embodiments, the base metal is a non-precious metal, namely other than palladium, platinum, iridium, rhodium, ruthenium, and gold. In some embodiments, the base metal is a transition metal other than a precious metal. In some embodiments, the base metal is nickel. In some embodiments, the non-metal is not oxygen. In some embodiments, the non-metal is phosphorus, and the ionic compound is a phosphide of the base metal. In some embodiments, the ionic compound is nickel phosphide, which serves as an efficient catalyst for electrochemical hypophosphite oxidation.

In some embodiments, a fuel cell includes: an anode; a cathode; and an ion conducting membrane disposed between the anode and the cathode, wherein the anode includes an anode catalyst layer including an ionic compound of a base metal, which is a non-precious metal, and a non-metal, which is not oxygen.

In some embodiments of the fuel cell, the base metal is a transition metal. In some embodiments of the fuel cell, the transition metal is nickel.

In some embodiments of the fuel cell, the non-metal is phosphorus, and the ionic compound is a phosphide of the base metal. In some embodiments of the fuel cell, the ionic compound is nickel phosphide. In some embodiments of the fuel cell, the ionic compound is in a particulate form including particles of the ionic compound. In some embodiments of the fuel cell, the anode further includes an anode catalyst support, and the particles of the ionic compound are disposed on the anode catalyst support.

In additional embodiments, a method of operating the fuel cell of any of the foregoing embodiments includes supplying an oxidant to the cathode and supplying a fuel including hypophosphite to the anode.

In further embodiments, a method of hypophosphite oxidation includes providing an electrode including a catalyst layer, wherein the catalyst layer includes an ionic compound of a base metal, which is a non-precious metal, and a non-metal, which is not oxygen; and exposing hypophosphite to the electrode while applying a potential to the electrode.

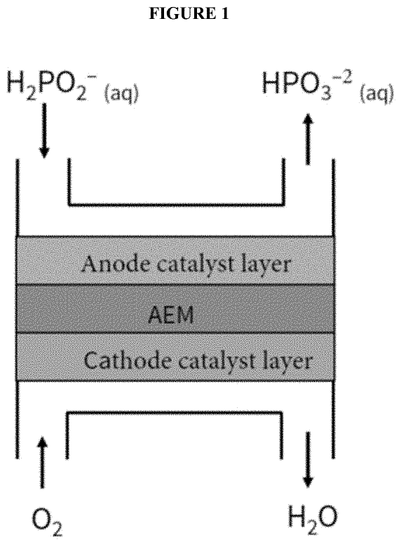

FIG. 1 shows an embodiment of a schematic of a direct hypophosphite fuel cell according to some embodiments. The fuel cell includes an anode, a cathode, and ion conducting membrane (in the form of an anion exchange membrane (AEM)) disposed between the anode and the cathode.

As shown in FIG. 1, an embodiment of the anode includes an anode catalyst layer. The anode catalyst layer includes an anode catalyst support and an ionic compound-based electrocatalyst of embodiments of this disclosure disposed on the anode catalyst support. The ionic compound-based electrocatalyst can be in a particulate or powder form including particles of the ionic compound, which form is amenable for incorporation into the fuel cell. In particular, the ionic compound-based electrocatalyst can be in the form of nanoparticles having sizes or an average size in a range of about 1 nm to about 1000 nm, about 1 nm to about 900 nm, about 1 nm to about 800 nm, about 1 nm to about 700 nm, about 1 nm to about 600 nm, about 1 nm to about 500 nm, about 1 nm to about 400 nm, about 1 nm to about 300 nm, about 1 nm to about 200 nm, or about 1 nm to about 100 nm. The ionic compound-based electrocatalyst also can be in the form of microparticles having sizes or an average size in a range of about 1 μm to about 1000 μm, about 1 μm to about 900 μm, about 1 μm to about 800 μm, about 1 μm to about 700 μm, about 1 μm to about 600 μm, about 1 μm to about 500 μm, about 1 μm to about 400 μm, about 1 μm to about 300 μm, about 1 μm to about 200 μm, or about 1 μm to about 100 μm. The anode catalyst support can include a material known for anode catalyst support. In some embodiments, the anode catalyst support can include a carbon-containing (or carbonaceous) material, stainless steel and/or titanium-based porous materials.

As shown in FIG. 1, an embodiment of the cathode includes a cathode catalyst layer. In some embodiments, the cathode catalyst layer includes a cathode catalyst support and a cathode electrocatalyst disposed on the cathode catalyst support. The cathode catalyst support can include a carbon-containing (or carbonaceous) material, stainless steel and/or titanium-based porous material.

During operation of the fuel cell, an oxidant (in the form of oxygen (O₂)) is supplied to the cathode via an oxidant conveyance mechanism, where oxygen is reduced, as catalyzed by the cathode catalyst layer, and a fuel (in the form of a solution of hypophosphite) is supplied to the anode via a fuel conveyance mechanism, where hypophosphite is oxidized, as catalyzed by the anode catalyst layer, to generate phosphite (HPO₃²⁻). Reactions at the anode and the cathode and an overall reaction in the fuel cell is reflected in the below.

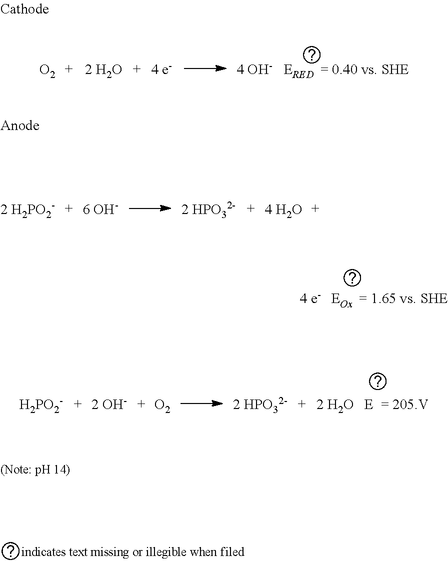

Advantages of the fuel cell include: 1) exceptional safety characteristics; 2) use of a solid fuel (in the form of hypophosphite) provides improved ease-of-use relative to liquid or gaseous fuels; and 3) zero CO₂ emissions after oxidation. Further, use of the ionic compound in the anode catalyst layer for hypophosphite electrocatalysis—which does not include any precious metal—reduces cost and provides high performance.

Beyond use in fuel cells, an ionic compound-based electrocatalyst of embodiments of this disclosure can have other applications for catalyzing hypophosphite oxidation.

### EXAMPLES

The following example describes specific aspects of some embodiments of this disclosure to illustrate and provide a description for those of ordinary skill in the art. The example should not be construed as limiting this disclosure, as the example merely provides specific methodology useful in understanding and practicing some embodiments of this disclosure.

Nickel phosphide is identified as an active, non-precious metal electrocatalyst for hypophosphite oxidation. Nickel phosphide is synthesized, and demonstration is made of oxidation of hypophosphite in relevant electrochemical conditions.

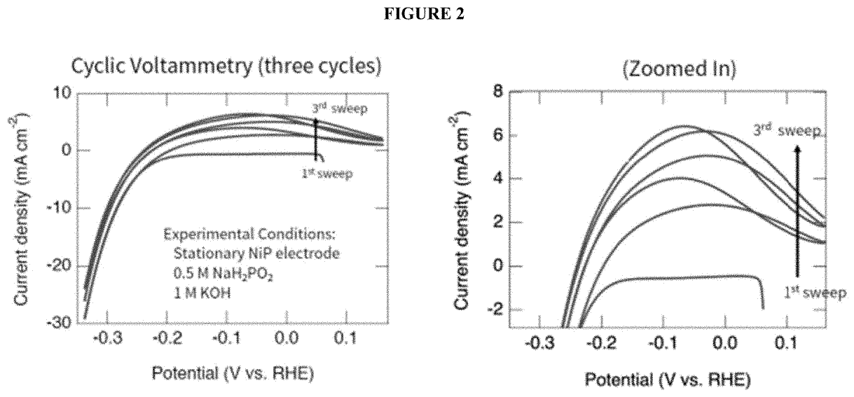

Referring to FIG. 2, demonstration is made of hypophosphite oxidation activity with a nickel phosphide electrode undergoing cyclic voltammetry. As shown, a positive current between −0.3 V and +0.1 V is indicative of desired catalytic activity.

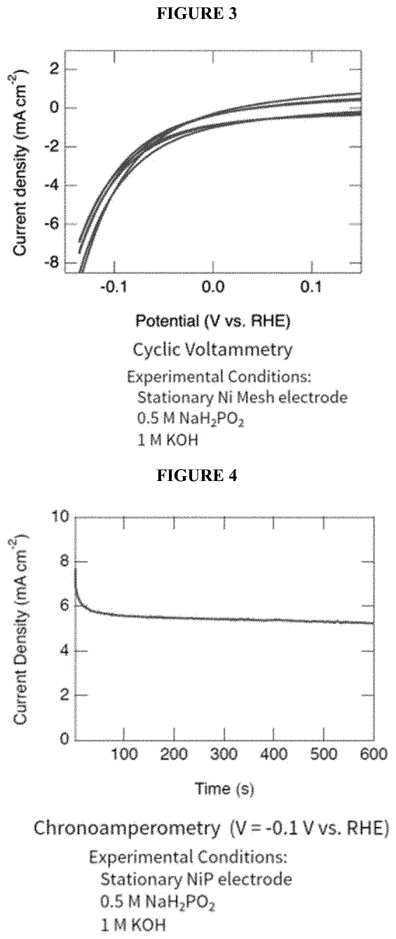

By contrast, as shown in FIG. 3, a comparative pure nickel electrode did not demonstrate the same level of oxidation activity. Also, nickel phosphide and pure nickel can have differing stabilities under various electrolyte conditions (e.g., pH, hypophosphite concentration, and so forth), and nickel phosphide can allow distinct fuel cell operating conditions.

Referring to FIG. 4, extended characterization is made of a nickel phosphide electrode, and over 10 minutes of stability is demonstrated, as reflected in the relatively stable current density over this time period.

As used herein, the singular terms “a,” “an,” and “the” include plural referents unless the context clearly dictates otherwise. Thus, for example, reference to an object can include multiple objects unless the context clearly dictates otherwise.

As used herein, the terms “connect,” “connected,” and “connection” refer to an operational coupling or linking. Connected objects can be directly coupled to one another or can be indirectly coupled to one another, such as via one or more other objects.

As used herein, the terms “substantially,” “substantial,” “approximately,” and “about” are used to describe and account for small variations. When used in conjunction with an event or circumstance, the terms can refer to instances in which the event or circumstance occurs precisely as well as instances in which the event or circumstance occurs to a close approximation. When used in conjunction with a numerical value, the terms can refer to a range of variation of less than or equal to ±10% of that numerical value, such as less than or equal to ±5%, less than or equal to ±4%, less than or equal to ±3%, less than or equal to ±2%, less than or equal to ±1%, less than or equal to ±0.5%, less than or equal to ±0.1%, or less than or equal to ±0.05%. For example, a first numerical value can be deemed to be “substantially” the same or equal to a second numerical value if the first numerical value is within a range of variation of less than or equal to ±10% of the second numerical value, such as less than or equal to ±5%, less than or equal to ±4%, less than or equal to ±3%, less than or equal to ±2%, less than or equal to ±1%, less than or equal to ±0.5%, less than or equal to ±0.1%, or less than or equal to ±0.05%.

Additionally, amounts, ratios, and other numerical values are sometimes presented herein in a range format. It is to be understood that such range format is used for convenience and brevity and should be understood flexibly to include numerical values explicitly specified as limits of a range, but also to include all individual numerical values or sub-ranges encompassed within that range as if each numerical value and sub-range is explicitly specified. For example, a ratio in the range of about 1 to about 200 should be understood to include the explicitly recited limits of about 1 and about 200, but also to include individual ratios such as about 2, about 3, and about 4, and sub-ranges such as about 10 to about 50, about 20 to about 100, and so forth.

While the disclosure has been described with reference to the specific embodiments thereof, it should be understood by those skilled in the art that various changes may be made and equivalents may be substituted without departing from the true spirit and scope of the disclosure as defined by the appended claim(s). In addition, many modifications may be made to adapt a particular situation, material, composition of matter, method, operation or operations, to the objective, spirit and scope of the disclosure. All such modifications are intended to be within the scope of the claim(s) appended hereto. In particular, while certain methods may have been described with reference to particular operations performed in a particular order, it will be understood that these operations may be combined, sub-divided, or re-ordered to form an equivalent method without departing from the teachings of the disclosure. Accordingly, unless specifically indicated herein, the order and grouping of the operations are not a limitation of the disclosure.

What is claimed is:

1. A fuel cell comprising:
an anode;
a cathode; and
an ion conducting membrane disposed between the anode and the cathode,
wherein the anode includes an anode catalyst layer including an ionic compound of a base metal, which is a non-precious metal, and a non-metal, which is not oxygen.

2. The fuel cell of claim 1, wherein the base metal is a transition metal.

3. The fuel cell of claim 2, wherein the transition metal is nickel.

4. The fuel cell of claim 1, wherein the non-metal is phosphorus, and the ionic compound is a phosphide of the base metal.

5. The fuel cell of claim 4, wherein the ionic compound is nickel phosphide.

6. The fuel cell of claim 1, wherein the ionic compound is in a particulate form including particles of the ionic compound.

7. The fuel cell of claim 6, wherein the anode further includes an anode catalyst support, and the particles of the ionic compound are disposed on the anode catalyst support.

8. A method of operating the fuel cell of claim 1, comprising supplying an oxidant to the cathode and supplying a fuel including hypophosphite to the anode.

9. A method of hypophosphite oxidation, comprising:
providing an electrode including a catalyst layer, wherein the catalyst layer includes an ionic compound of a base metal, which is a non-precious metal, and a non-metal, which is not oxygen; and
exposing hypophosphite to the electrode while applying a potential to the electrode.
